(19) United States
(12) Patent Application Publication
(10) Pub. No.: US 2022/0245120 A1
(43) Pub. Date: Aug. 4, 2022

(54) AUTOMATED GENERATION OF AUDIT LOG WITH APPLICATION-LEVEL METADATA USING REPLICATION LOG OF A DATABASE

(71) Applicant: Southern California Software Labs, LLC, La Jolla, CA (US)

(72) Inventor: Kyle Derek Hanson, La Jolla, CA (US)

(21) Appl. No.: 17/591,893

(22) Filed: Feb. 3, 2022

Related U.S. Application Data
(60) Provisional application No. 63/145,281, filed on Feb. 3, 2021.

(51) Int. Cl. G06F 16/23; G06F 16/2455

(52) U.S. Cl. CPC G06F 16/2358; G06F 16/24556; G06F 16/2456

(57) ABSTRACT

Automated generation of an audit log with application-level metadata using the replication log of a database. In an embodiment, the records of a replication log, output by a database, are accessed. The records represent metadata-related modifications to a metadata table, as well as data-related modifications to data table(s). Metadata, including application-level metadata, are extracted from metadata-related modifications and stored in a first intermediary table, such that the extracted metadata are associated with first identifiers. Representations of data-related modifications are stored in a second intermediary table in association with second identifiers. An audit log is generated by combining extracted metadata in the first intermediary table with representations of data-related modifications in the second intermediary table based on the first and second identifiers.

### CROSS-REFERENCE TO RELATED APPLICATIONS

The present application claims priority to U.S. Provisional Application No. 63/145,281, filed on Feb. 3, 2021, which is hereby incorporated herein by reference as if set forth in full.

### BACKGROUND

### Field of the Invention

The embodiments described herein are generally directed to auditing a database history, and, more particularly, to automatically generating an audit log that includes application-level metadata using a replication log of a database.

### Description of the Related Art

A database may be configured to maintain a replication log, which may also be referred to as a logical replication (e.g., in Postgres™), binary log (e.g., in MySQL™), change stream (e.g., in MongoDB™), or the like, depending on the particular database management system being used. The replication log comprises a record of all modifications to the database. For example, in the case of a database managed using Structured Query Language (SQL), the replication log may include a representation of every SQL statement that updates data (e.g., INSERT, UPDATE, CREATE, DELETE, and/or similar statements) or could have updated data (e.g., an INSERT, UPDATE, DELETE statement, even if it failed to match any rows).

The replication log for a database may be converted into a database history for analysis. However, since database management systems only have access to database-level information, at best, the replication logs produced by database management systems only contain database-level information. Thus, conventional database histories, derived from these replication logs, can only identify database-level attributes for subsequent analysis. Such replication logs and their resulting database histories do not enable analysis of application-level information, such as the user or the portion of the application that caused the modification. In other words, application-level information cannot be derived from the replication log and used to audit the database history. This significantly diminishes the value of the replication log to analytical functions such as cybersecurity, application management, database management, and the like.

### SUMMARY

Accordingly, systems, methods, and non-transitory computer-readable media are disclosed to create an audit log, which is annotated with application-level metadata, from a replication log for a database. Advantageously, such an audit log enables analysis of an application's behavior with respect to the database. In turn, this enables the automated detection of cybersecurity risks, data breaches, and/or the like, as well as the automation of other downstream functions.

In an embodiment, a method comprises using at least one hardware processor to: access a replication log output by a database, the replication log comprising a plurality of modification records, each of the plurality of modification records representing either a metadata-related modification to a dedicated metadata table in the database or a data-related modification to at least one data table in the database; for each modification record in the plurality of modification records that represents a metadata-related modification, extract metadata from the modification record, and store the extracted metadata in a first intermediary table such that it is associated with a first identifier, the extracted metadata comprising application-level metadata; for each modification record in the plurality of modification records that represents a data-related modification, determine a second identifier associated with metadata that is associated with the data-related modification, and store a representation of the data-related modification in a second intermediary table, such that the stored representation of the data-related modification is associated with the second identifier; and generate an audit log by combining extracted metadata stored in the first intermediary table with representations of data-related modifications stored in the second intermediary table based on the first identifiers and the second identifiers. The method may be executed as a daemon operating in a background of an operating system.

The plurality of modification records in the replication log may be logically arranged into a plurality of transactions, wherein each first identifier is a transaction identifier that identifies one of the plurality of transactions, and wherein each second identifier is a transaction identifier that identifies one of the plurality of transactions. Combining extracted metadata stored in the first intermediary table with representations of data-related modifications stored in the second intermediary table based on the first identifiers and the second identifiers may comprise, for each of the plurality of transactions: identifying extracted metadata and one or more representations of data-related modifications that are both associated with a same transaction identifier; combine the identified extracted data and one or more representations of data-related modifications into a single audit record; and write the single audit record to the audit log.

Each first identifier and each second identifier may be a metadata identifier that identifies a row in the first intermediary table. Storing the extracted metadata in a first intermediary table such that it is associated with a first identifier may comprise storing the extracted metadata in the first intermediary table indexed by the first identifier. Storing a representation of the data-related modification in a second intermediary table, such that the stored representation of the data-related modification is associated with the second identifier, may comprise storing the representation of the data-related modification in the second intermediary table indexed by a transaction identifier, and storing an association between the transaction identifier and the second identifier in a third intermediary table. Determining a second identifier associated with metadata that is associated with the data-related modification may comprise determining the second identifier as a column value for a predefined column that is represented in the data-related modification. Determining a second identifier associated with metadata that is associated with the data-related modification may comprise extracting the second identifier from a comment in a statement that is represented in the data-related modification.

Each first identifier and each second identifier may be a metadata identifier that identifies a row in the first intermediary table, wherein determining a second identifier associated with metadata that is associated with the data-related modification comprises determining the second identifier as a column value for a predefined column that is represented in the data-related modification. Each first identifier and each second identifier may be a metadata identifier that identifies a row in the first intermediary table, wherein determining a second identifier associated with metadata that is associated with the data-related modification comprises extracting the second identifier from a comment in a statement that is represented in the data-related modification.

The application-level metadata may comprise a user identifier. The application-level metadata may identify a portion of an application that produced the metadata-related modification. The portion of the application may be an online resource that is identified in the application-level metadata by a Uniform Resource Locator (URL).

The method may comprise using the at least one hardware processor to: receive a name of a table; receive a lookback time; retrieve a plurality of audit records from the audit log that predate the lookback time; and replay the plurality of audit records to create a snapshot of the table at the lookback time. Retrieving the plurality of audit records from the audit log that predate the lookback time may comprise retrieving only a plurality of audit records that consists of, for each value of a primary key of the table in the audit log, a most recent audit record that predates the lookback time and represents a modification to a row with that value of the primary key.

Any of the methods above may be embodied, individually or in any combination, in executable software modules of a processor-based system, such as a server, and/or in executable instructions stored in a non-transitory computer-readable medium.

### BRIEF DESCRIPTION OF THE DRAWINGS

The details of embodiments, both as to their structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates an example system, in which one or more of the processes described herein, may be implemented, according to an embodiment;

FIGS. 4A-4C illustrate a process for generating an audit log with application-level metadata from a replication log, according to a first embodiment;

FIGS. 5A-5C illustrate a process for generating an audit log with application-level metadata from a replication log, according to a second embodiment;

FIGS. 6A-6C illustrate a process for generating an audit log with application-level metadata from a replication log, according to a third embodiment; and

FIG. 7 illustrates a process for creating a past snapshot of a table, according to an embodiment.

### DETAILED DESCRIPTION

In an embodiment, systems, methods, and non-transitory computer-readable media are disclosed for generating an audit log with application-level metadata from a replication log. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

1.1. Infrastructure

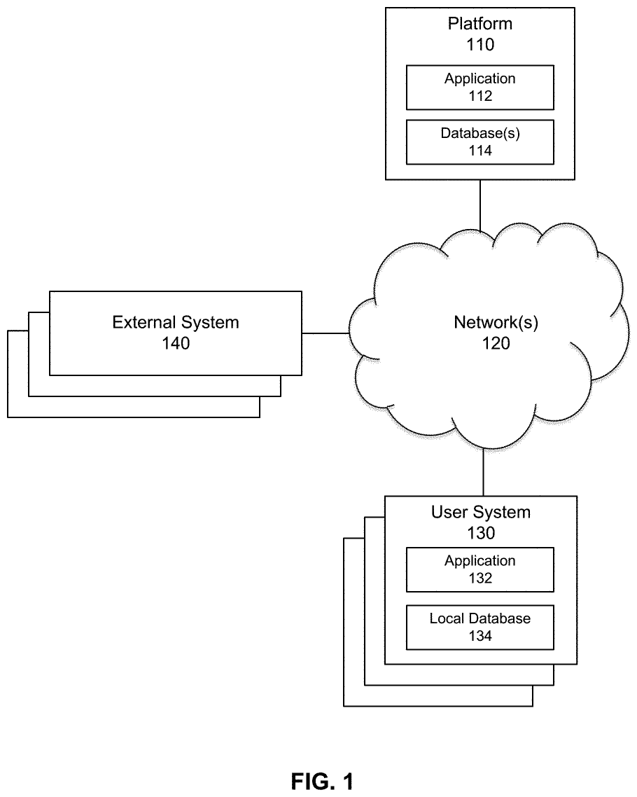

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also host or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases, including zero of one or more of these components.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like. Each user system 130 may host or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language by application 112. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation My SQL™, Oracle™ IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

1.2. Example Processing Device

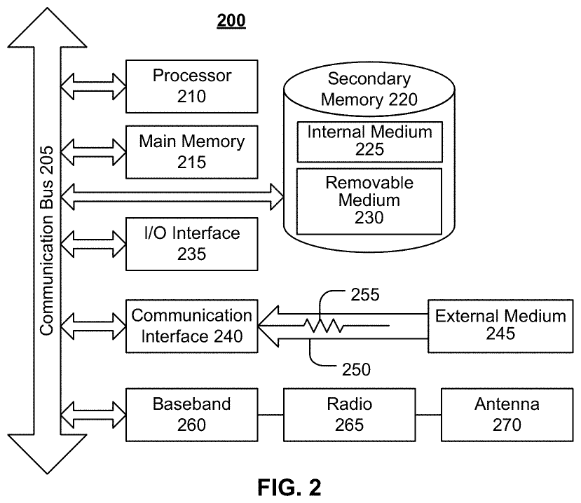

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, external system(s) 140, and/or other processing devices described or implied herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, Calif., any of the processors available from Advanced Micro Devices, Incorporated (AMD) of Santa Clara, Calif., any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like.

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

1.3. Example System

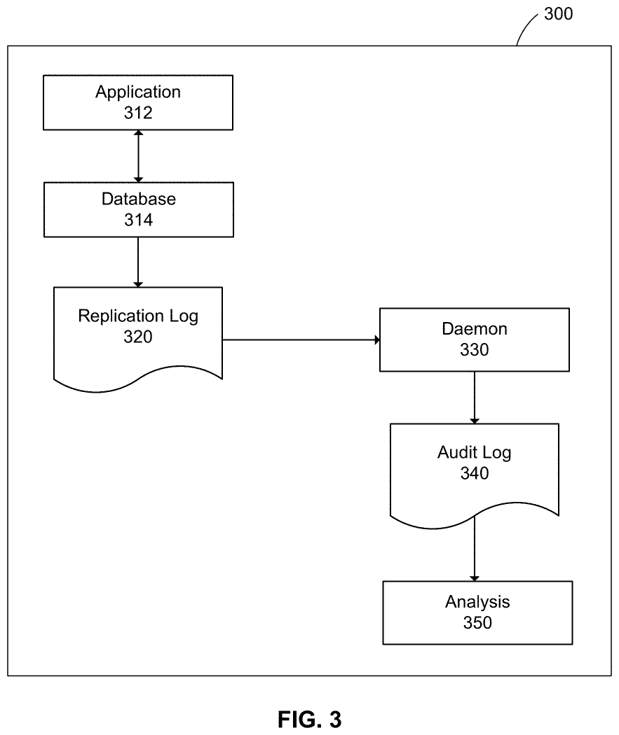

FIG. 3 illustrates an example system 300, in which one or more of the processes described herein, may be implemented, according to an embodiment. System 300 may comprise or consist of platform 110, user system 130, external system 140, or a combination of two or more of such systems, and may be implemented using one or more systems 200.

System 300 may host or support an application 312, which may correspond to server application 112 and/or client application 132, and a database 314, which may correspond to database 114 and/or local database 134. Application 312 reads from and writes to database 314. For example, database 314 may comprise one or more tables of a relational database, and application 312 may read from and write to these table(s) using a query language, such as SQL. Whenever application 312 writes to or otherwise modifies database 314, database 314 may automatically record the modification in a replication log 320. In other words, replication log 320 may comprise a record of every modification to database 314 within at least a set time window. Replication log 320 may be implemented in various manners, depending on the particular database management system, but is generally implemented as a real-time data stream or one or more log files stored in memory (e.g., secondary memory 220), for example, separate from database 314.

System 300 may comprise a daemon 330 that automatically monitors and consumes replication log 320. Daemon 330 may execute as an automated background process (i.e., in the background and without user intervention) of an operating system of system 300. Daemon 330 may consume replication log 320 in real time (e.g., as a subscription to a data stream) as database 320 writes to replication log 320. In this case, it should be understood that the term “real time” includes consumption in near-real time, which includes delays due to ordinary latencies in processing, data transfer, network communications, and/or the like. In an alternative embodiment, daemon 330 may consume replication log 320 periodically (e.g., from a log file), for example, at predefined intervals (e.g., every ten minutes, hourly, daily, etc.). It should be understood that, in this case, at each interval, daemon 330 may consume all records in replication log 320 that have not been previously consumed, or may consume a predefined number or size of records in replication log 320 that have not been previously consumed.

Daemon 330 outputs an audit log 340 based on the consumption of modification records from replication log 320. It should be understood that, when daemon 330 consumes replication log 320 in real time, daemon 330 may output audit records to audit log 340 in real time. Similarly, when daemon 330 consumes replication log 320 periodically, daemon 330 may output audit records to audit log 340 periodically (e.g., according to the same predefined intervals). As with replication log 320, audit log 340 may be implemented in various manners. For example, audit log 340 may comprise one or more log files, stored in memory and comprising audit records produced from corresponding modification records in replication log 320. In an embodiment, each audit record in audit log 340 may correspond to at least one modification record in replication log 320 and may comprise a representation of the modification, represented by the corresponding modification record, and metadata related to that modification.

This metadata may include application-level metadata comprising one or more values of application-level attributes of the modification. The application-level metadata may comprise any useful information that is available to application 312, but not ordinarily available to database 314. For example, the application-level metadata may comprise, without limitation, a user identifier (e.g., username, account number, first and last name, and/or the like) of a user who is logged into application 312 and whose interaction(s) with application 312 caused the modification, an application identifier that identifies application 312 or a type of the application 312, an identifier of a portion of application 312 (e.g., Uniform Resource Locator (URL) or tracing identifier for a webpage, function, asynchronous task, etc.) that caused or is related to the modification, session information regarding the session between application 312 and a user (e.g., between server application 112 and client application 132) during which the modification occurred, a unique tracing identifier (e.g., request identifier), a parent tracing identifier (e.g., identifying the action that triggered the action modifying the data), client information (e.g., browser information), the version of application 312 and/or a version control hash for application 312, performance information for application 312 (e.g., how long the relevant action took), and/or the like.

An analysis module 350 may automatically consume audit log 340 in real time, periodically, or in response to an event, and/or may consume audit log 340 in response to a user operation. Analysis module 350 may analyze the metadata-enhanced modification records (i.e., audit records) in audit log 340 to organize the audit records (e.g., to make them searchable across one or more dimensions) and/or detect one or more patterns of interest. Such organization(s) or pattern(s) of interest may be used to trigger responses or alerts, improve application 312 and/or database 314, generate usage statistics of application 312 and/or database 314 for reporting (e.g., via a graphical user interface), inform other downstream functions, determine the last user to modify a record (e.g., to resolve a data integrity issue when two or more users modify data concurrently), discover whether or not a data integrity issue was caused by an engineering mistake, recover the last value of a record in the event of an accidental overwrite, trigger webhooks or other protocols (e.g., to application 312 and/or external services) for additional processing, and/or the like. For example, if analysis module 350 detects a pattern representing a cyberattack (e.g., data breach, denial of service, etc.), analysis module 350 may trigger a response, such as prohibiting continued access to database 314 by application 312, terminating application 312, redirecting application 312 to a sandbox, alerting an administrator, and/or the like.

### 2. Process Overview

Embodiments of processes for generating an audit log with application-level metadata from a replication log will now be described in detail. It should be understood that the described processes may be embodied in one or more software modules that are executed by one or more hardware processors (e.g., processor 210). The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In general, embodiments of the disclosed process enable daemon 330 to associate metadata, including application-level metadata, with records of database modifications in replication log 320, to produce an audit log 340 comprising database modifications that are annotated or otherwise enhanced with metadata, including application-level metadata. In some cases, a particular database modification in replication log 320 may not have any associated metadata (e.g., due to the design of application 312, as a result of a write failure, etc.). In these cases, daemon 330 may write the database modification to an unannotated record in audit log 340. Thus, it is possible that audit log 340 could comprise both annotated and unannotated records.

Some of the disclosed embodiments utilize a metadata table in database 314. The metadata table may be a specially designated table (e.g., named “metadata table” or with any other predefined table name), comprising one or more columns for metadata parameters (or references to metadata parameters in another data source), including application-level attributes. Thus, daemon 330 may differentiate metadata-related modifications from data-related modifications based on what table is being modified. Specifically, if the metadata table is modified, then daemon 330 determines that the modification is a metadata-related modification. On the other hand, if any table, other than the metadata table, is modified, then daemon 330 determines that the modification is a data-related modification. It should be understood that a metadata-related or data-related modification may include any modification to a respective table, such as an update (e.g., UPDATE query) to a row in the respective table, an insertion (e.g., INSERT query) of a row into the respective table, a deletion (e.g., DELETE query) of a row from the respective table, and/or the like.

### 2.1. First Embodiment

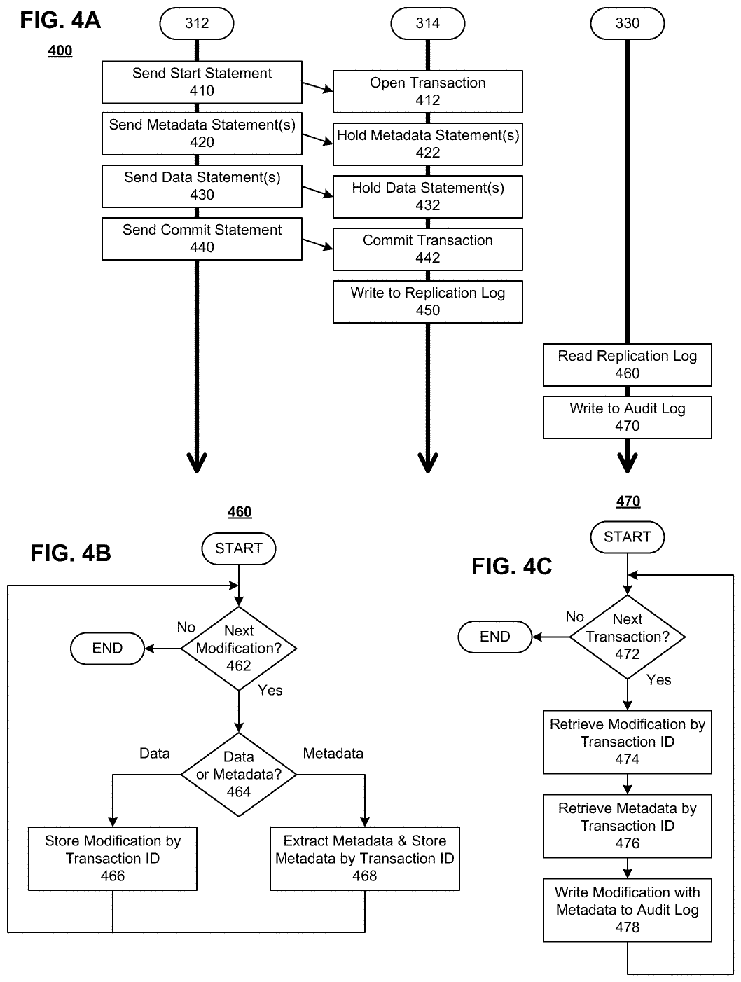

FIGS. 4A-4C illustrate a process 400 for generating an audit log 340 with application-level metadata from a replication log 320, according to a first embodiment that is transaction-based. Process 400 may be used when database 314 is not configured to automatically commit statements from application 312 to database 314. In this case, for each modification to database 314, application 312 opens a transaction (e.g., using a START statement), and database 314 will not write any statements until application 312 closes the transaction (e.g., using a COMMIT statement). Once application 312 closes the transaction, all of the statements in the open transaction will be written to database 314 as a single transaction (i.e., either all of the statements are written or none of the statements are written).

In replication log 320, the statements will be logically grouped by these transactions. For example, each transaction in replication log 320 may be bookended by a modification record representing the start of the transaction (e.g., START statement) and a subsequent modification record representing the end of the transaction (e.g., COMMIT statement). Thus, each discrete transaction may be determined by the detecting these two modification records, representing the start and end of the transaction.

At a high level, in process 400, while consuming replication log 320, daemon 330 will associate each transaction with a transaction identifier (e.g., when it encounters the modification record representing the start of the transaction). When daemon 330 encounters a data-related modification before encountering the modification record representing the end of the transaction, daemon 330 will associate that data-related modification with the same transaction identifier. Similarly, when daemon 330 encounters a metadata-related modification before encountering the modification representing the end of the transaction, it will extract the metadata added to the metadata table in the metadata-related modification and directly or indirectly associate that extracted metadata with the transaction identifier, thereby linking all data-related modifications in a transaction with the metadata for that transaction. Daemon 330 may then utilize this link to generate at least one audit record for the transaction and write that audit record to audit log 340.

FIG. 4A illustrates a timing diagram for subprocesses performed by application 312, database 314, and daemon 330, according to an embodiment. In subprocess 410, application 312 sends a statement (e.g., BEGIN or START) to start a new transaction to database 314. Responsively, in subprocess 412, database 314 opens a new transaction.

In subprocess 420, application 312 sends one or more statements to modify a metadata table in database 314. For example, these metadata-related statement(s) may insert application-level metadata associated with a modification to database 314 into the metadata table in database 314. In subprocess 422, database 314 receives and holds the metadata-related statement(s) until a commit statement is received.

In subprocess 430, application 312 sends one or more statements to modify one or more data tables in database 314. For example, these data-related statement(s) may affect data stored by and/or for application 312 in database 314. It should be understood that the metadata-related statement(s) sent in subprocess 420 and held in subprocess 422 reflect metadata related to these data-related modification(s). In particular, the metadata-related statement(s) may add metadata to the metadata table that represents application-level attributes of these data-related modification(s). In subprocess 432, database 314 receives and holds the data-related statement(s) until a commit statement is received.

It should be understood that subprocesses 420 and 430 may be performed in parallel or in any order. In other words, the metadata-related statement(s) may be prepared and sent in subprocess 420 before, simultaneously with, or after the data-related statement(s) are prepared and sent in subprocess 430. In addition, the metadata-related and data-related statements may comprise any type(s) of statements, including reads (e.g., SELECT, etc.) and/or writes (e.g., INSERT, UPDATE, CREATE, DELETE, etc.). However, of particular interest to disclosed embodiments, the metadata-related and data-related statements will frequently comprise writes that modify database 314. In an embodiment, all metadata-related statements are insertions (e.g., INSERT) and/or other writes.

In subprocess 440, application 312 sends a commit statement (e.g., COMMIT) to database 314. The commit statement represents that application 312 is committing the transaction, started by subprocess 410, consisting of the metadata-related statement(s) sent in subprocess 420 and the data-related statement(s) sent in subprocess 430. Table 1 below illustrates pseudocode representing one specific example of subprocesses 410, 420, 430, and 440:

TABLE 1

BEGIN;
INSERT INTO ‘metadata_table’ (‘user id’,...) VALUES (...);
UPDATE ‘data_table_a’ SET col_a=1 WHERE id=3;
DELETE FROM ‘data table b’ WHERE id=3;
INSERT INTO ‘data table c’ (...) VALUES (...);
COMMIT;

In subprocess 442, database 314 receives the commit statement and responsively commits the transaction to database 314. In other words, any modifications to database 314, represented in the statements sent since the start of the transaction, including any modifications to the metadata table and any data tables, are written to database 314 in a single atomic transaction. An atomic transaction refers to the requirement that either all of the statements in the transaction must be written or none of the statements in the transaction can be written.

Once the transaction has been committed, database 314 writes any modifications, which were made to the tables of database 314 in the transaction, as modification records to replication log 320. It should be understood that these modification records will include a representation of each modification to the metadata table in database 314, as well as a representation of each modification to a data table in database 314. In other words, replication log 320 will contain both the metadata-related and data-related modifications for each committed transaction.

In real time or periodically, daemon 330 reads replication log 320 in subprocess 460. In particular, daemon 330 may associate each record of a data-related modification (i.e., to a data table in database 314) with each record of a metadata-related modification (i.e., to the metadata table in database 314) within the same transaction. Daemon 330 may then write these transaction-based associations as annotated modification records (i.e., audit records) to audit log 340 in subprocess 470. Subprocesses 460 and 470 may utilize one or more intermediate tables to associate the metadata and data-related modifications to each other via a shared transaction identifier. It should be understood that subprocesses 460 and 470 may be performed in parallel with each other to write each audit record as it is generated from associated modification records in replication log 320, or alternatively, may be performed serially or in iterative batches.

FIG. 4B illustrates an example of subprocess 460 that may be executed by daemon 330, according to an embodiment. Via subprocess 462, daemon 330 iterates through every modification record under consideration in replication log 320. If no modification records remain to be considered (i.e., “No” in subprocess 462), subprocess 460 ends. Otherwise, if a modification record remains to be considered (i.e., “Yes” in subprocess 462), daemon 330 determines whether the modification record represents a data-related modification (i.e., a modification to a data table) or a metadata-related modification (i.e., a modification to the metadata table) in subprocess 464.

Daemon 330 may differentiate data-related modifications from metadata-related modifications in subprocess 464 by parsing the modification record to identify the name of the table in database 314 that was modified. If the name of the table corresponds to the predefined name of the metadata table, then daemon 330 determines that the modification record represents a metadata-related modification. Otherwise, if the name of the table does not correspond to the predefined name of the metadata table, then daemon 330 determines that the modification record represents a data-related modification. It should be understood that the name of the metadata table may be set to any name, as long as that name is provided to daemon 330 (e.g., as a constant or configurable parameter value).

If the modification is a data-related modification (i.e., “Data” in subprocess 464), a representation of the modification is stored in subprocess 466, such that it is retrievable by a unique transaction identifier associated with the transaction to which the data-related modifications belong. The representation of the modification may comprise any parameter values that may be derived from the modification record, such as the name of the table being modified, the name(s) of any columns being modified and/or the value(s) by which the column(s) are being modified (e.g., as parameter-value pairs), the raw query statement, and/or the like.

Otherwise, if the modification is a metadata-related modification (i.e., “Metadata” in subprocess 464), the metadata is extracted from the modification record and a representation of the metadata is stored in subprocess 468, such that it is retrievable by a unique transaction identifier associated with the transaction to which the metadata-related modifications belong. It should be understood that data-related modifications stored in subprocess 466 and metadata stored in subprocess 468, which belong to the same transaction, will each be associated with the same transaction identifier, such that they can be joined by the transaction identifier. The metadata may be extracted in subprocess 468 by parsing the modification record to identify parameter-value pairs that were included within the metadata-related statements. For example, if a statement was “INSERT INTO metadata (username, URL) VALUES(‘exampleuser’, ‘example.com\index.htm’)”, daemon 330 may extract “username=exampleuser” and “URL=example.com\index.htm” as parameter-value pairs representing the metadata that is stored in subprocess 468.

In both of subprocesses 466 and 468, the respective information may be stored in intermediate table(s) such that they are linked by the transaction identifier. Table 2 below illustrates pseudocode representing one specific example of subprocess 460 that uses intermediate tables:

```
Table 2
event_stream=get_replication_log( )
transaction_id=None
user_id=None
for event in event_stream:
  if event.is_transaction_begin( ):
    transaction_id=event.log_sequence_number
  elseif event.is_transaction_commit():
    execute_sql(“INSERT INTO ‘transactions’ (‘log_sequence_number’,
      ‘user_id’) VALUES (?,?), transaction_id, user_id)
    notify_transaction_done(transaction_id)
    transaction_id=None
  elseif event. table_name==“metadata_table”:
    event_data=event.column_data[“payload”]
    user_id=event_data[“user id”]
  else:
    execute_sql(“INSERT INTO ‘row_history (‘log_sequence_number’,
      ‘transaction_id’, ‘event_type’,‘column_data’) VALUES (?,?,?,?)”,
      event.log_sequence_number, transaction_id, event.type,
      event.column_data)
```

The example in Table 2 iterates through each modification record in replication log 320 and uses a relational database to store the intermediate tables. If the current modification record represents the beginning of a new transaction, a new transaction identifier is created for the transaction. If the current modification record represents a modification to the metadata table, the metadata is extracted from the metadata-related modification record. In this example, the metadata that is extracted is the user identifier, which is an application-level attribute. However, it should be understood that any metadata, including any other application-level metadata, may be included in and extracted from the metadata-related modification record in an identical or similar manner. If the current modification record represents a modification to any table other than the metadata table, information is extracted from the modification record and written to a first intermediate table (e.g., “row_history”) with the transaction identifier. If the modification record represents the end of a transaction, the previously extracted metadata is inserted into a second intermediate table (e.g., “transactions”) with the transaction identifier. Thus, entries in the first and second intermediate tables can be cross-referenced by their transaction identifiers.

Table 3 below illustrates pseudocode representing an alternative example of subprocess 460 that accounts for the possibility that replication log 320 may contain multiple metadata-related modifications for a single transaction. In this alternative example, a third intermediate table (e.g., “metadata”) is used to accumulate the metadata by the transaction identifier.

```
TABLE 3
event_stream=get_replication_log( )
transaction_id=None
for event in event stream:
  if event.is_transaction_begin( ):
    transaction_id=event.log sequence number
    execute_sql (“INSERT INTO ‘transactions’ (‘log_sequence_number’)
      VALUES (?), transaction_id)
  elseif event.is_transaction_commit( ):
    notify_transaction_done(transaction_id)
    transaction_id=None
  elseif event. table_name==“metadata_table”:
    event_data=event.column_data
    execute_sql (“INSERT INTO ‘metadata’ (‘log_sequence_number’,
      ‘transaction_id’, ‘user_id’) VALUES (?,?,?),”
      event.log_sequence_number, transaction_id, event_data[“user id”])
  else:
    execute_sql(“INSERT INTO ‘row_history’ {‘log_sequence_number’,
      transaction_id’,? ‘event_type’,‘column_data’) VALUES (?,?,?,?)”,
      event.log_sequence_number, transaction_id, event.type,
      event.column_data)
```

FIG. 4C illustrates an example of subprocess 470 that may be executed by daemon 330, according to an embodiment. Via subprocess 472, daemon 330 iterates through every transaction for which information was stored in subprocess 460. For example, daemon 330 may iterate through all transaction identifiers in the intermediate table(s) (e.g., in the “transactions” table in the examples in Tables 2 and 3). If no transactions remain to be considered (i.e., “No” in subprocess 472), subprocess 470 ends. Otherwise, if a transaction remains to be considered (i.e., “Yes” in subprocess 472), daemon 330 retrieves the modification that is associated with the respective transaction identifier in subprocess 474, and retrieves the metadata that is associated with the respective transaction identifier in subprocess 476. It should be understood that subprocesses 474 and 476 may be performed in any order or in parallel. In subprocess 478, representations of the retrieved modification and the retrieved metadata are combined and may be written as a single annotated modification record (i.e., audit record) to audit log 340.

In an embodiment which utilizes intermediate relational table(s), subprocesses 474 and 476 may be performed for all transactions using a single query statement. For example, a single SELECT statement for the values of relevant data-related and metadata-related columns, with a JOIN by transaction identifier, may be used to extract a set of data and metadata values for all transactions in the intermediate relational table(s). Then, in subprocess 478, daemon 330 may simply iterate through all extracted sets of values to output each extracted set of values as an audit record that associates each modification with its related metadata.

### 2.2. Second Embodiment

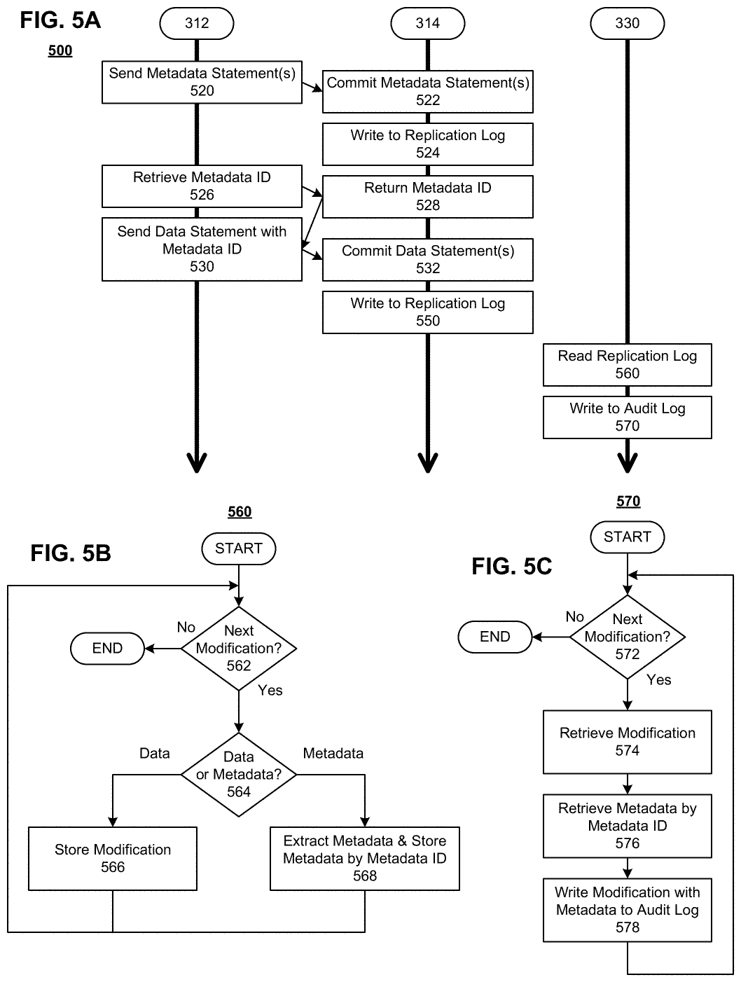

FIGS. 5A-5C illustrate a process 500 for generating an audit log 340 with application-level metadata from a replication log 320, according to a second embodiment that is column-based. Process 500 may be used when database 314 is configured to automatically commit statements from application 312 to database 314 as they are sent, or in any other case in which data-related modifications and their associated metadata-related modifications may be written in separate transactions. Unlike process 400, process 500 does not rely on transactions to associate data-related and metadata-related modifications. Rather, process 500 utilizes a predefined column value in the data-related statements to identify the associated metadata.

At a high level, in process 500, daemon 330 will monitor for data-related modifications and metadata-related modifications in replication log 320 which have the same metadata identifier as a value in respective metadata-identifier columns. Daemon 330 may cross-reference the metadata identifiers to generate audit records, and write those audit records to audit log 340.

FIG. 5A illustrates a timing diagram for subprocesses performed by application 312, database 314, and daemon 330, according to an embodiment. In subprocess 520, application 312 sends a statement to modify a metadata table in database 314. For example, the metadata-related statement may insert application-level metadata associated with a modification to database 314 into the metadata table in database 314. In subprocess 522, database 314 receives and responsively commits the metadata-related statement to database 314. In addition, in subprocess 524, database 314 writes the modification, which was made to the metadata table by the metadata-related statement, to replication log 320.

The metadata-related statement sent in subprocess 520 and committed in subprocess 522 may comprise inserting application-level metadata into a new row in the metadata table. The metadata table may be primarily indexed by a metadata identifier, such that each row in the metadata table is assigned a unique metadata identifier (e.g., either generated by application 312 or automatically generated by database 314). In subprocess 526, application 312 may retrieve the metadata identifier for the metadata statement committed in subprocess 522. Responsively, in subprocess 528, database 314 may return the metadata identifier to application 312.

In an alternative embodiment, database 314 may return the unique metadata identifier to application 312, when committing the metadata statement(s) in subprocess 622, such that subprocesses 526 and 528 are unnecessary. In yet another alternative embodiment, application 312 may generate the unique metadata identifier and incorporate this metadata identifier into the metadata statement(s) sent in subprocess 520, committed in subprocess 522, and represented in replication log 320 in subprocess 524. In this case, since application 312 already has the metadata identifier, subprocesses 526 and 528 may be omitted.

In subprocess 530, application 312 adds the retrieved metadata identifier to the one or more statements that modify one or more data tables in database 314, and sends these data-related statement(s) to database 314. The retrieved metadata identifier may be added as a value to a predefined column in the data table(s) that are being modified by the data-related statement(s). In particular, each data table in database 314, for which it is desired to audit application-level information, may include a dedicated metadata-identifier column. Thus, each row in such a data table may be associated with a metadata identifier by inserting a value into the metadata-identifier column of that row. Whenever the value(s) of a row in such a data table is modified, the value of the metadata-identifier column in that row may be updated with the metadata identifier (e.g., retrieved by subprocesses 526 and/or 528, or alternatively, generated by application 312) identifying a row in the metadata table (i.e., committed to the metadata table in subprocess 522) that represents the metadata associated with the modification of that row.

In an alternative embodiment, instead of adding the metadata identifier as a value in a specially designated column in the data-related statement(s), subprocess 530 may add the metadata itself as a value in a specially designated column in the data-related statement(s). In this case, subprocesses 520, 522, 524, 526, and 528 may be omitted, and database 314 does not need to maintain a dedicated metadata table to separately store the metadata. However, the overall size of database 314 will generally need to increase, especially where a significant amount of metadata is stored, since the metadata will be included in each row of each data table and may often be redundant across two or more rows. Thus, the use of a separate metadata table advantageously enables a reduction in the size of database 314 by reducing redundancy in the stored metadata.

Table 4 below illustrates pseudocode representing one specific example of subprocesses 520 and 530 in an embodiment in which application 312 retrieves the metadata identifier (e.g., in subprocess 526), whereas Table 5 below illustrates pseudocode representing one specific example of subprocesses 520 and 530 in an embodiment in which application 312 generates the metadata identifier (e.g., omitting subprocesses 526 and 528):

TABLE 4

BEGIN;
INSERT INTO ‘metadata_table’ (‘user_id’,...) VALUES (...) RETURNING m_id;
UPDATE ‘data_table_a’ SET col_a=1, metadata_id=m_id WHERE id=3;
INSERT INTO ‘data_table_c’ (col_b, metadata_id) VALUES (99, m_id);
COMMIT;

TABLE 5

BEGIN;
INSERT INTO ‘metadata_table’ (id’,‘user_id’,...) VALUES (‘c0642...’,1,...);
COMMIT;
BEGIN;
UPDATE ‘data_table SET col_a=1, metadata_id=c0642...' WHERE id=3;
COMMIT;

In subprocess 532, database 314 receives and commits the data-related statement(s) to database 314. In addition, in subprocess 550, database 314 writes the modification, which was made to data table(s) by the data-related statement(s), to replication log 320. It should be understood that, when a data-related statement includes a value for the metadata-identifier column (i.e., the metadata identifier), the corresponding data-related modification record in replication log 320 will also contain the metadata identifier. In other words, the relevant metadata identifiers are embedded in the associated data-related modification records in replication log 320.

In real time or periodically, daemon 330 reads replication log 320 in subprocess 560. In particular, daemon 330 may read each data-related modification record, including the embedded metadata identifier in the metadata-identifier column, and each metadata-related modification record, which itself includes a metadata identifier in a metadata-identifier column. Daemon 330 may associate the metadata from each metadata-related modification record with a corresponding data-related modification via the shared metadata identifier.

Daemon 330 may then write these column-based associations as annotated modification records (i.e., audit records) to audit log 340 in subprocess 570. Subprocesses 560 and 570 may utilize one or more intermediate tables to associate the metadata and data-related modifications to each other via the shared metadata identifiers. It should be understood that subprocesses 560 and 570 may be performed in parallel with each other to write each audit record as it is generated from associated modification records in replication log 320, or alternatively, may be performed serially or in iterative batches.

FIG. 5B illustrates an example of subprocess 560 that may be executed by daemon 330, according to an embodiment. Via subprocess 562, daemon 330 iterates through every modification record under consideration in replication log 320. If no modification record remains to be considered (i.e., “No” in subprocess 562), subprocess 560 ends. Otherwise, if a modification record remains to be considered (i.e., “Yes” in subprocess 562), daemon 330 determines whether the modification record represents a data-related modification (i.e., a modification to a data table) or a metadata-related modification (i.e., a modification to the metadata table) in subprocess 564. Subprocess 562 may be similar or identical to subprocess 462 in process 400, and therefore, any description of subprocess 462 may apply equally to subprocess 562, and vice versa. In addition, subprocess 564 may be similar or identical to subprocess 464 in process 400, and therefore, any description of subprocess 464 may apply equally to subprocess 564.

If the modification is a data-related modification (i.e., “Data” in subprocess 564), a representation of the modification is stored in subprocess 566, such that it is retrievable by or otherwise linked to the metadata identifier embedded in the modification record. The metadata identifier may be extracted in subprocess 566 by parsing the modification record to identify the value to which the metadata-identifier column, in the data table modified in the modification record, is being set. It should be understood that daemon 330 may store the name of the metadata-identifier column as a constant or configurable parameter value, such that daemon 330 may easily identify the value of this column using a simple keyword search for the name of this column in the data-related modification record.

Otherwise, if the modification is a metadata-related modification (i.e., “Metadata” in subprocess 564), the metadata is extracted from the modification record and a representation of the metadata is stored in subprocess 568, such that it is retrievable by the metadata identifier from the modification record. The metadata and metadata identifier may be extracted in subprocess 568 by parsing the modification record to identify parameter-value pairs that were included within the metadata-related statements, in an identical or similar manner as described with respect to subprocess 468.

In both of subprocesses 566 and 568, the respective information may be stored in intermediate table(s), such that they are linked by the metadata identifier. Table 6 below illustrates pseudocode representing one specific example of subprocess 560 that uses intermediate tables, and in which the application-level metadata consists of the value of a user identifier (i.e., “user_id”):

TABLE 6

```
event_stream=get_replication_log( )
transaction_id=None
metadata_id=None
for event in event_stream:
  if event.is_transaction_begin( ):
    transaction_id=event.log_sequence_number
  elseif event.is_transaction_commit( ):
  execute_sql(“INSERT INTO ‘transactions’ (‘log_sequence_number’,
    ‘metadata_id’) VALUES (?,?), transaction_id, metadata_id)
  notify_transaction_done(transaction_id)
  transaction_id=None
elseif event. table_name==“metadata_table”:
  event_data=event.column_data
  metadata_id=event_data[“id”]
  user_id=event_data[“user id”]
  execute_sql(“INSERT INTO ‘transaction_metadata’ rid’,‘user_id’) VALUES
    (?,?)”, metadata_id, user_id)
else:
  event_data=event.column_data
  metadata_id=event data[“metadata_id”]
  execute_sql(“INSERT INTO ‘row_history’ (‘log_sequence_number’,
    ‘transaction_id’, ‘event_type’,‘column_data’) VALUES (?,?,?,?)”,
    event.log_sequence_number, transaction_id, event.type,
    event.column_data)
```

Notably, in the example in Table 6, modifications are stored by a transaction identifier in an intermediate table named “row_history”, and metadata are stored by a metadata identifier in an intermediate table named “transaction_metadata”. Rows in these two intermediate tables are related to each other by an intermediate table named “transactions” that link specific transaction identifiers to specific metadata identifiers. Thus, the rows in the “row_history” table, representing data-related modifications and including transaction identifiers, are retrievable by their corresponding metadata identifiers by virtue of the link between transaction identifiers and metadata identifiers in the rows in the “transactions” table. In other words, when a modification is referred to herein as being retrievable or retrieved by a metadata identifier, this does not require that the modification be directly retrievable or retrieved by the metadata identifier. Rather, such retrievals may be indirect via a linking table such as the “transactions” table in the example in Table 6.

FIG. 5C illustrates an example of subprocess 570 that may be executed by daemon 330, according to an embodiment. Via subprocess 572, daemon 330 iterates through every modification for which information was stored in subprocess 560. For example, daemon 330 may iterate through all modifications in one or more intermediate table(s) (e.g., through every row in the “transactions” table in the example in Table 6). If no modification remains to be considered (i.e., “No” in subprocess 572), subprocess 570 ends. Otherwise, if a modification remains to be considered (i.e., “Yes” in subprocess 572), daemon 330 retrieves the modification in subprocess 574 (e.g., by linking the transaction identifier in the “transactions” table to the transaction identifier in the “row_history” table in the example in Table 6), and retrieves the metadata by a metadata identifier in subprocess 576 (e.g., by linking the metadata identifier in the “transactions” table to the “transactions_metadata” table in the example in Table 6). It should be understood that subprocesses 574 and 576 may be performed in any order or in parallel. In subprocess 578, representations of the retrieved modification and the retrieved metadata are combined and may be written as a single annotated modification record (i.e., audit record) to audit log 340.

In an embodiment which utilizes intermediate relational table(s), subprocesses 572, 574, and 576 may be performed for all modifications using a single query statement. For example, a single SELECT statement for the values of relevant data-related and metadata-related columns, with a JOIN, may be used to extract a set of data and metadata values for all modifications in the intermediate relational table(s) (e.g., for all rows in the “transactions” table in the example in Table 6). For example, using the example in Table 6, rows in the “row_history” table and “transactions_metadata” table may be joined by the transaction identifier and metadata identifier in each row of the “transactions” table. Then, in subprocess 578, daemon 330 may simply iterate through all sets of values to output each set of values as an audit record that associates each modification with its related metadata.

Notably, in this second embodiment, soft deletions may be implemented through a “tombstone” column in the data table(s). A tombstone column identifies whether or not a row has been deleted. When a row is deleted from a data table, the tombstone column is set to a value that indicates that the row has been deleted. An application that is querying the data table should ignore any rows for which the value of the tombstone column indicates that the row has been deleted, to thereby avoid retrieving deleted rows. Whenever the tombstone column is set to a value that indicates that the row has been deleted, the metadata-identifier column in that row may also be updated, such that the deletion of the row is tied to metadata in the metadata table. Thus, any deletion performed on the data table may be associated with application-level metadata about that deletion.

### 2.3. Third Embodiment

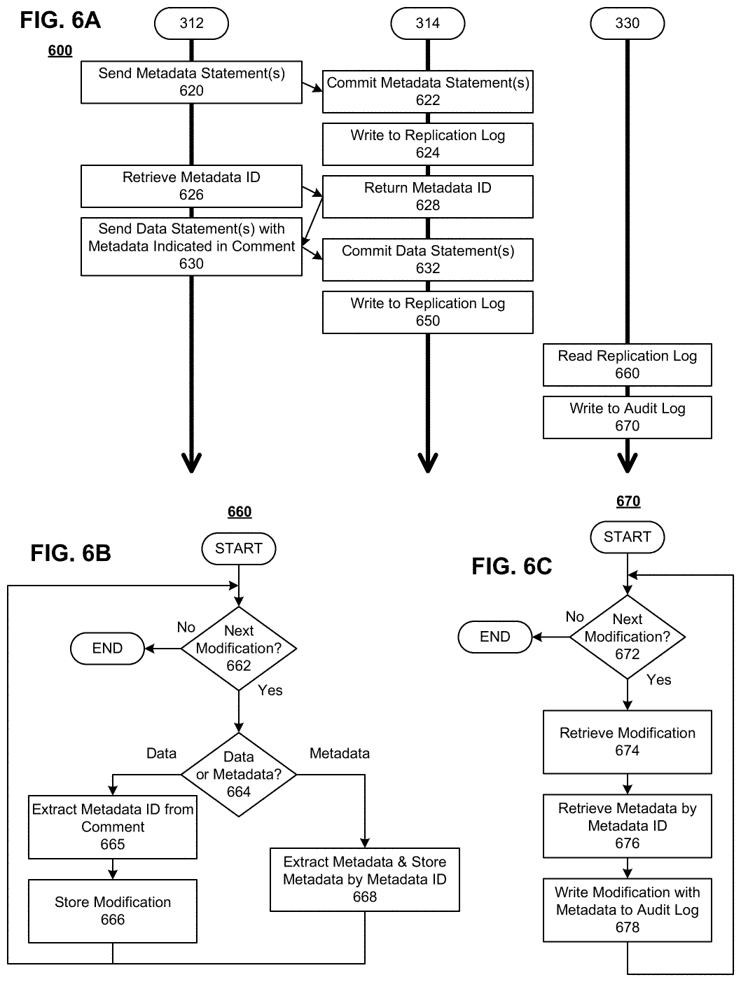

FIGS. 6A-6C illustrate a process 600 for generating an audit log 340 with application-level metadata from a replication log 320, according to a third embodiment that is comment-based. Process 600 may be used regardless of whether or not database 314 is configured to automatically commit statements from application 312 to database 314. In addition, unlike the second embodiment, process 600 may be used without the addition of a metadata column to data tables in database 314, and potentially without the need for a metadata table in database 314. Process 600 may be suitable for database management systems that incorporate the original query string of data-related statements in the data-related modification records in replication log 320, such that the original query string can be inspected and comments extracted from replication log 320.

At a high level, in process 600, daemon 330 will monitor data-related modifications that have a metadata identifier—or, in an alternative embodiment, metadata itself—embedded in comments. Daemon 330 may cross-reference the metadata identifiers in the data-related modifications to metadata identifiers in metadata-related modifications to generate audit records and write those audit records to audit log 340. In the alternative embodiment, daemon 330 may extract the metadata from the comments of a data-related modification and associate the extracted metadata with the modification, represented by that data-related modification, to generate the audit records which are written to audit log 340.

FIG. 6A illustrates a timing diagram for subprocesses performed by application 312, database 314, and daemon 330, according to an embodiment. In subprocess 620, application 312 sends a statement to modify a metadata table in database 314. For example, the metadata-related statement may insert application-level metadata associated with a modification to database 314 into the metadata table in database 314. In subprocess 622, database 314 receives and responsively commits the metadata-related statement to database 314. In addition, in subprocess 624, database 314 writes the modification, which was made to the metadata table by the metadata-related statement, to replication log 320.

The metadata-related statement sent in subprocess 620 and committed in subprocess 522 may comprise inserting application-level metadata into a new row in the metadata table. The metadata table may be primarily indexed by a metadata identifier, such that each row in the metadata table is assigned a unique metadata identifier (e.g., either generated by application 312 or automatically generated by database 314). In subprocess 626, application 312 may retrieve the metadata identifier for the metadata statement committed in subprocess 622. Responsively, in subprocess 628, database 314 returns the metadata identifier to application 312.

In an alternative embodiment, database 314 may return the unique metadata identifier to application 312, when committing the metadata statement(s) in subprocess 622, such that subprocesses 626 and 628 are unnecessary. In yet another alternative embodiment, application 312 may generate the unique metadata identifier and incorporate this metadata identifier into the metadata statement(s) sent in subprocess 620, committed in subprocess 622, and represented in replication log 320 in subprocess 624. In this case, since application 312 already has the metadata identifier, subprocesses 626 and 628 may be omitted.

In subprocess 630, application 312 adds the retrieved metadata identifier to a comment in the one or more statements that modify one or more data tables in database 314, and sends these data-related statement(s) to database 314. The retrieved metadata identifier may be added as a value in a comment in the data-related statement(s). The particular format of the comment will depend on the database management system being used. As an example, the metadata identifier or a parameter-value pair (e.g., comprising or consisting of the value of the metadata identifier paired with a parameter name or other indication that the value represents a metadata identifier, such as “metadata_identifer=[value of metadata identifier]”) may be appended to a comment character (e.g., “#” in some database management systems) that indicates the start of a comment or within a comment pattern (e.g., “/* . . . */” in some database management systems). The comment, comprising or consisting of the comment character or pattern and metadata identifier (e.g., “#metadata_identifer=[value of metadata identifier]” or “/*metadata_identifier=[value of metadata identifier]*/”), may be appended to or inserted into each of the data-related statement(s). In other words, the metadata identifier for a particular modification is embedded into a comment within each of the data-related statement(s) representing that modification.

In an alternative embodiment, instead of embedding the metadata identifier into a comment in the data-related statement(s), subprocess 630 may embed the metadata itself into a comment in the data-related statement(s). In this case, subprocesses 620, 622, 624, 626, and 628 may be omitted, and database 314 does not need to maintain a metadata table to separately store the metadata. Notably, this embodiment would reduce the memory requirements of database 314, relative to the first and second embodiments, since neither a metadata table nor any metadata columns are required. However, such an embodiment may only be applicable when comments are conveyed from the committed statements to replication log 320.

Table 7 below illustrates pseudocode representing one specific example of subprocesses 620 and 630 in an embodiment in which application 312 generates the metadata identifier (e.g., omitting subprocesses 626 and 628) and inserts the metadata identifier into a comment, whereas Table 8 below illustrates pseudocode representing one specific example of subprocess 630 in an embodiment in which application 312 inserts the metadata (e.g., user identifier) directly into a comment (e.g., omitting subprocesses 620, 622, 624, 626, and 628).

TABLE 7

BEGIN;
INSERT INTO ‘metadata table’ (id’,‘user_id’,...) VALUES (‘c0642...’,1,...);
COMMIT;
BEGIN;
UPDATE /* METADATA_ID=c0642... */ ‘data table’ SET col_a=1WHERE id=3;
COMMIT;

TABLE 8

BEGIN;
UPDATE /* USER ID=1 */ ‘data_table’ SET col_a=1 WHERE id=3;
COMMIT;

In subprocess 632, database 314 receives and commits the data-related statement(s) to database 314. In addition, in subprocess 650, database 314 writes the modification, which was made to data table(s) by the data-related statement(s), to replication log 320. It should be understood that, in this third embodiment, when a data-related statement includes a comment with a value for a metadata identifier or the metadata itself, the corresponding data-related modification record in replication log 320 will also contain the metadata identifier or metadata itself. In other words, the metadata identifiers or the metadata itself are embedded in the associated data-related modification records in replication log 320.

In real time or periodically, daemon 330 reads replication log 320 in subprocess 660. In particular, daemon 330 may read each data-related modification record, including the embedded metadata identifier in any comment, and each metadata-related modification record, which itself includes a metadata identifier in a metadata-identifier column. Daemon 330 may associate the metadata from each metadata-related modification record with a corresponding data-related modification via the metadata identifier.

In the alternative embodiment in which the metadata itself, instead of metadata identifiers, are included in comments in the data-related statements, daemon 330 may parse the metadata directly from the data-related statements. In this case, daemon 330 may associate the embedded metadata directly with the data-related modification without having to utilize a metadata identifier to link the information.

In any case, daemon 330 may write the comment-based associations as annotated modification records (i.e., audit records) to audit log 340 in subprocess 670. In an embodiment which utilizes metadata identifiers to link data-related modifications to metadata-related modifications, subprocesses 660 and 670 may utilize one or more intermediate tables to associate the metadata and data-related modifications to each other via the shared metadata identifiers. It should be understood that subprocesses 660 and 670 could be performed in parallel to write each audit record as it is generated, or alternatively, may be performed serially or in iterative batches.

FIG. 6B illustrates an example of subprocess 670 that may be executed by daemon 330, according to an embodiment. Via subprocess 662, daemon 330 iterates through every modification record under consideration in replication log 320. If no modification record remains to be considered (i.e., “No” in subprocess 662), subprocess 660 ends. Otherwise, if a modification record remains to be considered (i.e., “Yes” in subprocess 662), daemon 330 determines whether the modification record represents a data-related modification (i.e., a modification to a data table) or a metadata-related modification (i.e., a modification to the metadata table) in subprocess 664. Subprocess 662 may be similar or identical to subprocess 462 in process 400 and subprocess 562 in process 500, and therefore, any description of subprocesses 462 and 562 may apply equally to subprocess 662, and vice versa. In addition, subprocess 664 may be similar or identical to subprocess 464 in process 400 and subprocess 564 in process 500, and therefore, any description of subprocesses 464 and 564 may apply equally to subprocess 664.

If the modification is a data-related modification (i.e., “Data” in subprocess 664), the metadata identifier is extracted from a comment in the data-related modification in subprocess 665, and then a representation of the modification is stored in subprocess 666, such that it is retrievable by or otherwise linked to the metadata identifier extracted from the comment. The metadata identifier may be extracted by parsing the modification record to determine whether or not it contains a predefined comment character (e.g., “#”) or comment pattern (e.g., “/* . . . */”) indicating the presence and/or value of a metadata identifier. It should be understood that daemon 330 may store the comment character, comment pattern, and/or parameter name of the metadata identifier as constant or configurable parameter values, such that daemon 330 may easily identify the comment and its contents using a simple keyword search or regular expression.

Otherwise, if the modification is a metadata-related modification (i.e., “Metadata” in subprocess 664), the metadata is extracted from the modification record and a representation of the metadata is stored in subprocess 668, such that it is retrievable by the metadata identifier from the modification record. The metadata and metadata identifier may be extracted in subprocess 668 by parsing the modification record to identify parameter-value pairs that were included within the metadata-related statements, in an identical or similar manner as described with respect to subprocess 468 and/or 568.

In both of subprocesses 666 and 668, the respective information may be stored in intermediate table(s), such that they are linked by the metadata identifier. Table 9 below illustrates pseudocode representing one specific example of subprocess 660 that uses intermediate tables, and in which the application-level metadata consists of the value of a user identifier (i.e., “user_id”):

TABLE 9

```
event_stream=get_replication_log( )
transaction_id=None
metadata_id=None
for event in event_stream:
  if event.is_transaction_begin( ):
    transaction_id=event.log_sequence_number
  elseif event.is_transaction_commit( ):
    execute_sql(“INSERT INTO ‘transactions’ (‘log_sequence_number’,
      ‘metadata_id’) VALUES (?,?), transaction_id, metadata_id)
    notify_transaction_done(transaction_id)
    transaction_id=None
  elseif event. table_name==“metadata_table”:
    event_data=event.column_data
      metadata_id=event data[“id”]
  user_id=event_data[“user id”]
  execute_sql(“INSERT INTO ‘transaction_metadata (‘id’,‘user_id’) VALUES
    (?,?)”, metadata_id, user_id)
else:
  comment=get_comment_from_sql(event.sql)
  metadata_id=get_metadata_id_from_comment (comment)
  execute_sql(“INSERT INTO 'row_history' (slog_sequence_number’,
    ‘transaction_id’, ‘event_type’,‘column_data’) VALUES (?,?,?,?)”,
    event.log_sequence_number, transaction_id, event.type,
    event.column data)
```

Notably, in the example in Table 9, modifications are stored by a transaction identifier in an intermediate table named “row_history”, and metadata are stored by a metadata identifier in an intermediate table named “transaction_metadata”. Rows in these two intermediate tables are related to each other by an intermediate table named “transactions” that link specific transaction identifiers to specific metadata identifiers. Thus, the rows in the “row_history” table, representing data-related modifications and including transaction identifiers, are retrievable by their corresponding metadata identifiers by virtue of the link between transaction identifiers and metadata identifiers in the rows in the “transactions” table.

Table 10 below illustrates pseudocode representing one specific example of an alternative subprocess 660 in an embodiment which embeds the metadata itself (e.g., a user identifier in this example), instead of a metadata identifier, into comments in the data-related statements. Notably, in this embodiment, database 314 does not need to maintain a metadata table.

```
TABLE 10
event _stream=get_replication_log( )
transaction_id=None
user_id=None
for event in event_stream:
  if event.is_transaction_begin( ):
    transaction_id=event.log_sequence_number
  elseif event.is_transaction_commit( ):
    execute sql(“INSERT INTO ‘transactions’ (‘log_sequence_number’,
      ‘user_id’) VALUES (?,?), transaction_id, user_id)
    notify_transaction_done(transaction_id)
    transaction_id=None
  elseif event.is_sql( ):
    comment=get_comment_from_sql(event.sql)
    user_id=get_user_id_from_comment (comment)
  else:
    execute_sql(“INSERT INTO ‘row_history (‘log sequence number’,
      ‘transaction_id’, ‘event_type’,‘column_data’) VALUES (?,?,?,?)”,
      event.log_sequence_number, transaction_id, event.type,
      event.column_data)
```

FIG. 6C illustrates an example of subprocess 670 that may be executed by daemon 330, according to an embodiment. Via subprocess 672, daemon 330 iterates through every modification for which information was stored in subprocess 660. For example, daemon 330 may iterate through all modifications in one or more intermediate table(s) (e.g., through every row in the “transactions” table in the example in Table 9). If no modification remains to be considered (i.e., “No” in subprocess 672), subprocess 670 ends. Otherwise, if a modification remains to be considered (i.e., “Yes” in subprocess 672), daemon 330 retrieves the modification in subprocess 674 (e.g., by linking the transaction identifier in the “transactions” table to the transaction identifier in the “row_history” table in the example in Table 9), and retrieves the metadata by a metadata identifier in subprocess 676 (e.g., by linking the metadata identifier in the “transactions” table to the “transactions_metadata” table in the example in Table 9). It should be understood that subprocesses 674 and 676 may be performed in any order or in parallel. In subprocess 678, representations of the retrieved modification and the retrieved metadata are combined and may be written as a single annotated modification record (i.e., audit record) to audit log 340.

In an embodiment which utilizes intermediate relational table(s), subprocesses 672, 674 and 676 may be performed for all modifications using a single query statement. For example, a single SELECT statement for the values of relevant data-related and metadata-related columns, with a JOIN, may be used to extract a set of data and metadata values for all modifications in the intermediate relational table(s) (e.g., for all rows in the “transactions” table in the example in Table 9). For example, using the example in Table 9, rows in the “row_history” table and “transactions_metadata” table may be joined by the transaction identifier and metadata identifier in each row of the “transactions” table. Then, in subprocess 678, daemon 330 may simply iterate through all sets of values to output each set of values as an audit record that associates each modification with its related metadata.

In an alternative embodiment, in which the metadata itself, instead of metadata identifiers, are embedded in comments in the data-related statements, subprocesses 660 and 670 may be simplified. For instance, using the example in Table 10, no “transactions_metadata” table is required. Each row in the “row_history” table is associated with metadata by virtue of the “transactions” table which associates transaction identifiers with metadata. In other words, in subprocess 660, for each modification in replication log 320, a representation is stored in the “row_history” table with a transaction identifier, the metadata is extracted from the comment (e.g., as described with respect to subprocess 665), and the transaction identifier is stored with the extracted metadata in the “transactions” table. Then, in subprocess 670, for each row in the “transactions” table, the metadata from the “transactions” table is joined with the modification from the “row_history” table via the transaction identifier in each table, and the combined record is written as an audit record to audit log 340.

### 2.4. Example Usage Scenarios for Audit Log

Advantageously, since the audit records in audit log 340 are annotated with application-level metadata, analysis module 350 and/or other downstream functions may make automated decisions that are informed by application-level information. For example, analysis module 350 may consume audit log 340 to make the audit records searchable by time, the name of the table that was modified, the name of the column that was modified, parameter values in the metadata (e.g., user identifier associated with the modification, name or type of application 312 that made the modification, URL that produced the modification, function of application 312 or location in application 312 that performed the modification, etc.), and/or the like. Users or other software modules may utilize this searchable version of audit log 340 to inform decision-making and answer questions about the data in database 314.

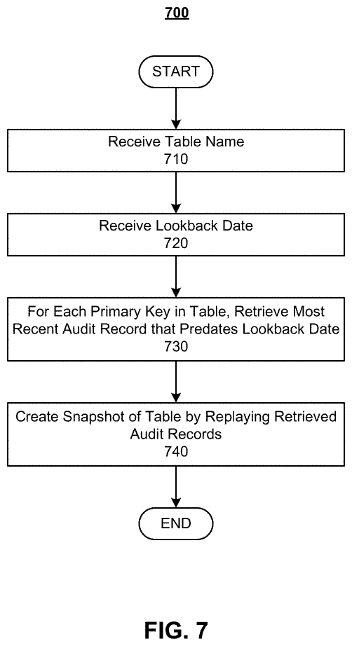

As another example, analysis module 350 may utilize audit log 340 to reconstruct a past snapshot of one or more tables in database 314 at any arbitrary point in time. In particular, since audit log 340 represents all modifications to the tables in database 314, those modifications can be replayed up to a past point in time, in order to get a snapshot of database 314 at that past point in time. For example, FIG. 7 illustrates a process 700 for creating a past snapshot of a table, according to an embodiment. Process 700 may be implemented by analysis module 350.

Initially, the name of the table for which the past snapshot is desired may be received in subprocess 710, and the date of the past snapshot, referred to as the “lookback time,” may be received in subprocess 720. The name of the table and/or the lookback time may be received from another software module, or may be manually received from an operator of analysis module 350 (e.g., via input(s) of a graphical user interface). It should be understood that subprocesses 710 and 720 may be performed in any order or in parallel.

In subprocess 730, the most recent audit record that predates the lookback time, received in subprocess 720, is retrieved from audit log 340 for each value of the primary key in the table that was named in subprocess 710. Subprocess 730 may be implemented by selecting all audit records in audit log 340 that predate the lookback time, and then iterating over the audit records in reverse chronological order (i.e., from most recent to least recent), and, for each unique primary key, keeping the first audit record that is encountered (i.e., the most recent audit record predating the lookback time) with that primary key, while ignoring any subsequent audit records (i.e., predating the most recent audit record predating the lookback time) that are encountered with a previously seen primary key. In an alternative embodiment, in which each audit record is identified by a monotonic sequence number (e.g., number, alphanumeric character string, byte string, etc.) whose value represents an order in which the modification, represented by the audit record, was executed, subprocess 730 may be implemented by the following or similar query:

SELECT MAX(log_sequence_number) FROM audit log GROUP BY table name, row primary key WHERE timestamp <? ORDER BY table name, row primary key;
wherein “log_sequence_number” is the monotonic sequence number and the lookback time, received in subprocess 720, is substituted into the placeholder “?”. It should be understood that additional filters may be incorporated into the statement above (e.g., to restrict the query to a single table with the name received in subprocess 710).

In subprocess 740, the audit records, retrieved in subprocess 730, may be replayed to create a snapshot of the table, named in subprocess 710, at the lookback time received in subprocess 720. In particular, the structure (e.g., columns and data types) of the table may be identified from database 314, and the table may be replicated (e.g., in database 314 or another database) with the same structure. In an embodiment, the structure of the replicated table may be altered by adding a metadata column to hold the value of the metadata identifier or the metadata itself from the respective audit records. Then, for each audit record, the row in the audit record (e.g., by an UPDATE or INSERT) may be replayed into the replicated table. In other words, the same column values that are updated or inserted in the original table in the audit record are updated and inserted into the replicated table using the same columns and data types as the original table. In an embodiment in which the replicated table comprises a metadata column, the metadata or metadata identifier from the audit record may also be added to the metadata column. After all of the audit records have been replayed, the replicated table will represent a snapshot (i.e., same rows with the same column values) of the original table at the lookback time. In addition, in an embodiment, the replicated table also comprises the metadata associated with the most recent modification to each row. The replicated table may be used for a rollback, as part of a larger snapshot (e.g., of database 314 and/or the state of platform 110), and/or for any other downstream function or analysis.

In an alternative embodiment, all audit records that predate the lookback time may be retrieved in subprocess 730 for replay, instead of just the most recent audit records predating the lookback time. While such an embodiment would require significantly more processing time by analysis module 350, it may be necessary if it is possible for modifications in audit log 340 to only modify a portion of a row in the table (e.g., a subset of columns in the row). In this case, multiple audit records may be required for each primary key in order to identify the values of all columns in the corresponding row of the table at the lookback time. In subprocess 740, all of these audit records may be replayed in chronological order to obtain a snapshot of the table.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
access a replication log output by a database, the replication log comprising a plurality of modification records, each of the plurality of modification records representing either a metadata-related modification to a dedicated metadata table in the database or a data-related modification to at least one data table in the database;
for each modification record in the plurality of modification records that represents a metadata-related modification,
extract metadata from the modification record, and
store the extracted metadata in a first intermediary table such that it is associated with a first identifier, the extracted metadata comprising application-level metadata;
for each modification record in the plurality of modification records that represents a data-related modification,
determine a second identifier associated with metadata that is associated with the data-related modification, and
store a representation of the data-related modification in a second intermediary table, such that the stored representation of the data-related modification is associated with the second identifier; and
generate an audit log by combining extracted metadata stored in the first intermediary table with representations of data-related modifications stored in the second intermediary table based on the first identifiers and the second identifiers.

2. The method of claim 1, wherein the plurality of modification records in the replication log are logically arranged into a plurality of transactions, wherein each first identifier is a transaction identifier that identifies one of the plurality of transactions, and wherein each second identifier is a transaction identifier that identifies one of the plurality of transactions.

3. The method of claim 2, wherein combining extracted metadata stored in the first intermediary table with representations of data-related modifications stored in the second intermediary table based on the first identifiers and the second identifiers comprises, for each of the plurality of transactions:
identifying extracted metadata and one or more representations of data-related modifications that are both associated with a same transaction identifier;
combine the identified extracted data and one or more representations of data-related modifications into a single audit record; and
write the single audit record to the audit log.

4. The method of claim 1,
wherein each first identifier and each second identifier is a metadata identifier that identifies a row in the first intermediary table,
wherein storing the extracted metadata in a first intermediary table such that it is associated with a first identifier comprises storing the extracted metadata in the first intermediary table indexed by the first identifier,
wherein storing a representation of the data-related modification in a second intermediary table, such that the stored representation of the data-related modification is associated with the second identifier, comprises
storing the representation of the data-related modification in the second intermediary table indexed by a transaction identifier, and
storing an association between the transaction identifier and the second identifier in a third intermediary table.

5. The method of claim 4, wherein determining a second identifier associated with metadata that is associated with the data-related modification comprises determining the second identifier as a column value for a predefined column that is represented in the data-related modification.

6. The method of claim 4, wherein determining a second identifier associated with metadata that is associated with the data-related modification comprises extracting the second identifier from a comment in a statement that is represented in the data-related modification.

7. The method of claim 1, wherein each first identifier and each second identifier is a metadata identifier that identifies a row in the first intermediary table, and wherein determining a second identifier associated with metadata that is associated with the data-related modification comprises determining the second identifier as a column value for a predefined column that is represented in the data-related modification.

8. The method of claim 1, wherein each first identifier and each second identifier is a metadata identifier that identifies a row in the first intermediary table, and wherein determining a second identifier associated with metadata that is associated with the data-related modification comprises extracting the second identifier from a comment in a statement that is represented in the data-related modification.

9. The method of claim 1, wherein the application-level metadata comprises a user identifier.

10. The method of claim 1, wherein the application-level metadata identifies a portion of an application that produced the metadata-related modification.

11. The method of claim 10, wherein the portion of the application is an online resource that is identified in the application-level metadata by a Uniform Resource Locator (URL).

12. The method of claim 1, further comprising using the at least one hardware processor to:
receive a name of a table;
receive a lookback time;
retrieve a plurality of audit records from the audit log that predate the lookback time; and
replay the plurality of audit records to create a snapshot of the table at the lookback time.

13. The method of claim 12, wherein retrieving the plurality of audit records from the audit log that predate the lookback time comprises retrieving only a plurality of audit records that consists of, for each value of a primary key of the table in the audit log, a most recent audit record that predates the lookback time and represents a modification to a row with that value of the primary key.

14. The method of claim 1, wherein the method is executed as a daemon operating in a background of an operating system.

15. A system comprising:
at least one hardware processor; and
one or more software modules that are configured to, when executed by the at least one hardware processor,
access a replication log output by a database, the replication log comprising a plurality of modification records, each of the plurality of modification records representing either a metadata-related modification to a dedicated metadata table in the database or a data-related modification to at least one data table in the database,
for each modification record in the plurality of modification records that represents a metadata-related modification,
extract metadata from the modification record, and
store the extracted metadata in a first intermediary table such that it is associated with a first identifier, the extracted metadata comprising application-level metadata;
for each modification record in the plurality of modification records that represents a data-related modification,
determine a second identifier associated with metadata that is associated with the data-related modification, and
store a representation of the data-related modification in a second intermediary table, such that the stored representation of the data-related modification is associated with the second identifier, and
generate an audit log by combining extracted metadata stored in the first intermediary table with representations of data-related modifications stored in the second intermediary table based on the first identifiers and the second identifiers.

16. A non-transitory computer-readable medium having instructions stored therein, wherein the instructions, when executed by a processor, cause the processor to:
access a replication log output by a database, the replication log comprising a plurality of modification records, each of the plurality of modification records representing either a metadata-related modification to a dedicated metadata table in the database or a data-related modification to at least one data table in the database;
for each modification record in the plurality of modification records that represents a metadata-related modification,
extract metadata from the modification record, and
store the extracted metadata in a first intermediary table such that it is associated with a first identifier, the extracted metadata comprising application-level metadata;
for each modification record in the plurality of modification records that represents a data-related modification,
determine a second identifier associated with metadata that is associated with the data-related modification, and
store a representation of the data-related modification in a second intermediary table, such that the stored representation of the data-related modification is associated with the second identifier; and
generate an audit log by combining extracted metadata stored in the first intermediary table with representations of data-related modifications stored in the second intermediary table based on the first identifiers and the second identifiers.
